(19) United States
(12) Patent Application Publication
(10) Pub. No.: US 2026/0022731 A1
(43) Pub. Date: Jan. 22, 2026

(54) Locking Washer

(71) Applicant: Heico Befestigungstechnik GmbH, Ense (DE)

(72) Inventors: Frank Lutter, Welver-Stocklarn (DE); Stefan Vornweg, Werl (DE)

(21) Appl. No.: 18/943,327

(22) Filed: Nov. 11, 2024

(30) Foreign Application Priority Data
Jul. 18, 2024 (DE) 20 2024 104 016.3

(51) Int. Cl. F16B 39/24; F16B 39/282

(52) U.S. Cl. CPC F16B 39/24; F16B 39/282

(57) ABSTRACT

A lock washer having a central through-opening for the passage of a clamping shaft, for example the shaft of a clamping bolt, and having a locking structure on its flat sides. At least some of the positive structures of the locking structure on one flat side of the lock washer are arranged offset in the circumferential direction in relation to positive structures on the other flat side wherein each positive structure on the opposite flat side of the washer has a negative structure extending over the radial extension of the washer, the width of which in the circumferential direction of the washer corresponds to a multiple of the width of a positive structure.

### RELATED APPLICATION

This application claims priority to German application DE 20 2024 104 016.3 filed Jul. 18, 2024, which is incorporated-by-reference herein.

### BACKGROUND

The disclosure relates to a lock washer having a central through-opening for the passage of a clamping shaft, for example the shaft of a clamping bolt, and having a locking structure on its flat sides.

Such lock washers, which are sometimes also referred to as locking washers, are used as anti-rotation and co-rotation devices and are connected for this purpose in a screw connection between two clamping partners. Such lock washers are used in the clamping of screw connections by which two flanges are connected to one another. Such a lock washer is then arranged between a bolt head or a nut as the first clamping partner with respect to the lock washer and a flange outer side as the second clamping partner. The screw connection can then be tightened from the outside of the opposite flange without it being necessary to lock the nut opposite to the clamping side or the bolt head located there. Such lock washers can also be used on the clamping side of a screw connection in order to prevent undesired loosening after clamping. The lock washers which are initially also used as a co-rotation safeguard during the clamping are also used for this purpose.

Various designs of lock washers are known from the prior art. Such lock washers have a locking structure which increases friction with respect to the abutting clamping partner on their flat sides facing away from one another, for example in the form of radially extending clamping/locking ribs. In the case of such lock washers, the ribs are used to increase the surface pressure by force concentration in order to press the latter into the surface of the clamping partner with the available clamping force and thus prevent the clamping partner, which is clamped using such a lock washer, from being unintentionally loosened relative to the other clamping partner. Sometimes pairs of lock washers are also used for this purpose. Because of their design, such pairs of lock washers are referred to as pairs of wedge lock washers.

According to another design for increasing the surface pressure, such lock washers are produced from a spring steel and bear locking teeth bent over from the plane of the washer on their outer circumference. The desired anti-loosening safeguard is also achieved with such a lock washer by means of the locking teeth which bear against the surface of the clamping partner due to the spring force with increased surface pressure and the sharp edge. However, such lock washers made of spring steel cannot be used when it comes to bracing larger parts, especially those subject to high dynamic loads, such as shafts that have to be connected to one another in wind turbines. Such a lock washer is known from DE 20 2019 104 561 U1, for example.

In the case of this lock washer, the two flat sides are equipped with a locking structure having tips. The tips of this locking structure are designed so that they penetrate superficially into the material of the clamping partner that is to be secured against rotation. For this purpose, the tips are tapered towards their free end, starting from their base surface. Due to the tips formed by the locking structure, this is already the case when only a relatively small clamping force is applied, due to the clamping force concentrated on the tips of the locking structure. The form fit thus created locks the clamping partner to which the torque required to tighten the bolt fastening is not applied. With such a lock washer, it is therefore possible to prepare a screw bolt fastening in connection with the arrangement of the clamping partners for the purpose of the intended clamping to such an extent that one of the two clamping partners is already connected to the at least one component to be clamped in a manner secured against rotation, the other clamping partner is screwed onto the threaded shaft and is pre-tensioned with such a torque that the clamping partner locked by the lock washer no longer rotates with it when a further torque (clamping force) is applied. The preparation of such a pre-tensioned screw bolt fastening is also fundamentally possible without tools or only with small-sized tools. To apply the torque intended for clamping, a larger tool is generally required, which then only needs to be applied to the clamping partner, for example a clamping nut, which is to be clamped relative to the other clamping partner countered by the lock washer. Thus, with regard to the accessibility of a torque tool, only the clamping partner to be tightened has to be accessible.

US 2017/0021478 A1 describes another lock washer in FIGS. 15A to 15C for preventing a lock nut from rotating. As a locking structure, the two flat sides each bear radially extending clamping ribs which are separated from one another by a groove. The locking structure of this previously known lock washer is designed in the manner of a groove. The radial extension of these clamping ribs, which are of rather small dimensions with respect to their cross-sectional area, is limited to a central section of the lock washer, which results in a concentration of force for easier pressing thereof into the surface of the abutting clamping partner. The areas of the flat sides of this lock washer that are adjacent to the locking structure in the radial direction are used as contact surfaces for flat contact on the clamping partner abutting thereon. This limits the penetration depth of the clamping ribs into the surface of the clamping partner abutting the flat side in each case. These previously known lock washers are produced from a relatively thick material. The structuring of the flat sides is created by machining. The lock washer described in DE 20 2019 104 561 U1, on the other hand, is a stamped part, wherein the locking structure has been created by means of an embossing pressing process.

Lock washers as described in DE 20 2019 104 561 U1 or also in US 2017/0021478 A1 are based on the principle that the desired anti-loosening device or protection against co-rotation when tightening the screw connection is provided by a form-fit acting in the circumferential direction between the locking structure and the material of the respective clamping partner abutting thereon. For this reason, the locking structure having its positive structures has to be pressed into the surface of the abutting clamping partner. It is therefore necessary for the positive structures to have a higher hardness than the hardness of the clamping partner abutting thereon. In addition, a corresponding clamping force is required in order to ensure that the positive structures of the locking structure are pressed into the clamping partner abutting thereon as intended.

The foregoing examples of related art and limitations therewith are intended to be illustrative and not exclusive. Other limitations will become apparent to those skilled in the art upon a reading of the specification and a study of the drawings.

### SUMMARY

The following embodiments and aspects thereof are described and depicted in conjunction with systems, tools, and methods which are meant to be illustrative and not limiting in scope. In various embodiments, one or more problems have been reduced or eliminated, while other embodiments are directed to other improvements.

Proceeding from this background, one aspect of the disclosure is to propose a lock washer for preventing an unintentional loosening of a screw connection or for ensuring an anti-rotation protection, with which, when used in a screw connection, the desired effect can already be achieved with lower demands on the lock washer.

According to one embodiment, this may be achieved by a lock washer of the type mentioned at the beginning, in which at least some of the positive structures of the locking structure on one flat side of the lock washer are arranged offset in the circumferential direction to positive structures on the other flat side, and in which each positive structure on the opposite flat side of the locking washer is arranged with a negative structure extending over the radial extent of the lock washer, whose width in the circumferential direction of the lock washer corresponds to a multiple of the width of a positive structure.

In this lock washer, the vertices of the positive structures of the locking structure are arranged at a distance from one another viewed in the circumferential direction, wherein at least some, but preferably all, of the positive structures on one flat side of the lock washer are arranged offset from the vertices of the positive structures on the other flat side of the washer. Therefore, these positive structures are located on one flat side of the lock washer in a position where a negative structure is located on the opposite flat side. Typically, in the axial direction, the center of a negative structure (center between two positive structures) is aligned with the positive structure of the opposite flat side. The spacing of the positive structures from one another in the circumferential direction corresponds to a multiple of their height, for example 4 to 10 times at their radially outer end. The width of a negative structure is multiple times greater in the circumferential direction of the lock washer than the width of the positive structures spaced apart from one another. The spacing of the positive structures from one another relates to their spacing, insofar as they are pressed or are to be pressed into the surface of a clamping partner by the clamping process. As a result of this spacing of the vertices of the positive structures, viewed in the circumferential direction of the washer, the number of positive structures is significantly reduced in relation to the number of such structures in other conventional lock washers. This results in a concentration of force on the smaller number of positive structures in comparison with such prior art. This in turn allows the positive structures to be designed so that they can extend over the entire radial extension of the lock washer, for example in the form of clamping ribs. In contrast to other previously known lock washers, these do not need to be limited to a section of the radial extension of the locking washer in order to achieve a force concentration, so that they can be pressed into the surface of an adjacent clamping partner with the available clamping force or the applied torque. The possibility of utilizing the entire radial extension of the flat sides of the lock washer improves the desired form-fit acting in the circumferential direction, so that even a small penetration depth of the vertices of the positive structures into the material of the clamping partner adjacent thereto results in a very effective form-fit in the circumferential direction. This is achieved above all without having to apply higher clamping forces.

This spacing of the vertices of the positive structures and their offset between the two opposing flat sides also has the result that when a screw connection is tightened with such a lock washer interconnected, a clamping force is coupled into the lock washer by the clamping force coupling into a positive structure on one flat side due to the negative structure on the other flat side opposite to this positive structure, via which the negative structure of the opposite flat side located between two positive structures seeks to be bent in the axial direction in the elastic range. This is possible due to the span of the positive structures spaced apart from one another on the opposite flat side or the width of the negative structure. This is designed so that, as a result of the circumferentially spaced support of the lock washer with its positive structures on the surface of the clamping partner adjacent thereto, an elastic deformation can be carried out in the area of the section of this negative structure or a part thereof by clamping. In this respect, during the clamping of such a lock washer, a pre-tension acting in the axial direction of the screw connection is incorporated in the lock washer, specifically within the scope of the material elasticity of the lock washer. When using such a lock washer, the clamping force required for such a screw connection to remain tightened as intended is thus maintained to a sufficient degree even in the event of vibrations or thermal length changes. In this respect, this lock washer ensures that the flat sides abut the clamping partners abutting thereon, and can typically also abut flatly, and the lock washer nevertheless exerts a certain pre-tension acting in the axial direction in the manner of a wave spring on the adjacent clamping partners. The material used for such a lock washer is the usual material for lock washers, for example an unalloyed steel having a low carbon content, such as grade/quality 1.1191.

The special design of this lock washer allows it to be produced with only a relatively low material thickness, for example with material thicknesses between 2 and 5 mm, thus in a material thickness in which these lock washers can easily be shaped with regard to their outline geometry by means of a punching process and the locking structure can be created by means of a embossing pressing process. Machining, which would otherwise be complex, is not necessary for this lock washer, in particular not to create the locking structure. Rather, the creation of the locking structure by means of a pressing process that embosses the surface also has the advantage that at least the vertices of the positive structures are formed by a cold forming process in the course of this process. This results in a certain degree of work hardening, so that special hardening of the locking structure is generally not necessary. If the hardness of the vertices of the positive structures produced by such cold forming is not sufficient for certain applications, they can of course be additionally hardened.

The locking structure on the two flat sides of such a lock washer is typically identical in its structure.

In some embodiments of such a lock washer, the positive structures are preferably designed as clamping ribs extending in the radial direction. In this way, the entire radial extension of the lock washer can be used to form such a positive structure. Such clamping ribs extending in the radial direction can have a straight course, i.e. can be aligned exactly radially, for example. A course of the clamping ribs which encloses a certain angle with the radial direction is also entirely possible, as well as for the clamping ribs to be curved, wherein the vertex of the curve points in the clamping direction. Other courses of such clamping ribs are also possible.

The height of the clamping ribs is typically not excessively high, in particular when the depth of pressing into the clamping partner adjacent thereto is predetermined by the height. Typically, the height of the clamping ribs does not exceed their width. According to a preferred embodiment example, the height of the clamping ribs is only approximately 40 to 60% of their width.

Such clamping ribs preferably have a constant cross-sectional geometry and cross-sectional area over their radial extension. This ensures that such a positive structure can be pressed uniformly into the material of the clamping partner abutting thereon over the radial extension of the lock washer.

The negative structure located between two positive structures is generally designed as a flat surface or at least comprises such a section adjacent to the two neighboring positive structures. These flat surface sections located in the plane of the flat side are used as support or contact surface sections to the surface of the adjacent clamping partner when the positive structures are pressed superficially into the material of the latter. If such a lock washer is to be used with a pre-tension incorporated therein by the clamping process, and nevertheless a surface contact at least in surface sections on the respective clamping partner is intended, there is a section in the center of the negative structure which forms the greatest depth of the negative structure. The two contact surface sections bordering a positive structure are then separated from one another by such a section. According to a preferred embodiment example, the width of such a recessed negative structure section is constant viewed in the circumferential direction, so that the same pre-tension is incorporated into the radially outer lock washer sections by the positive structure opposite to this deepest section on the other flat side as in the area of the mouth of the through-opening. Such a recessed section can be provided by a U-shaped recess or also by a stepped formation of the negative structure in the circumferential direction. In the case of a stepped embodiment of the negative structure, the flanks between the two steps are preferably inclined, specifically in the direction of the lower section. The flank formation in the form of a flexure is advantageous. It is also possible to form a stepped negative structure which has more than one step. In such a single-step or multi-step embodiment of the negative structures, the width of the deepest step in the circumferential direction of the locking washer is greater than the width of the positive structure on the opposite flat side. This deepest section of a negative structure does not contact the surface of the clamping partner abutting this flat side, even when the screw connection is tightened.

Regardless of the design of the negative structure, the extension of a negative structure in the area of the mouth of the through-opening is approximately 4 to 7 times larger than the extension of a positive structure in the same direction. In a preferred embodiment example, the ratio of the circumferential extension of a positive structure to a negative structure is 1:5.

The through-opening is typically formed on both flat sides by a chamfer, in particular a 45° chamfer. This makes it easier to place such a washer on the shaft of a clamping or threaded bolt, using which the screw connection is to be established and tightened.

The lock washer can be used in various clamping arrangements. For example, such a lock washer can be inserted into a clamping arrangement in which the lock washer is arranged on the passive side of a clamping arrangement, for example in contact with a nut, and in which a reaction washer is arranged on the active side. In a preferred example of such a clamping arrangement, the reaction washer functionality is combined with an anti-loosening device, namely by using a pair of wedge lock washers, wherein one of the two washers has a larger outer diameter than the other washer and thus projects circumferentially beyond the smaller washer in the radial direction. In this projecting radial section of the larger wedge lock washer, rotary driving contours are introduced to support a torque tool in the radial direction.

In addition to aspects and embodiments described above, further aspects and embodiments will become apparent by reference to the drawings, wherein like reference numerals generally designate corresponding structures in the several views.

### BRIEF DESCRIPTION OF THE DRAWINGS

The description below is provided with reference to the attached figures, where:

FIG. 1 shows a side view of the detail of one example lock washer according to the disclosure, arranged between two clamping partners of a screw connection,

FIG. 2 shows a perspective view of another example lock washer according to the disclosure,

FIG. 3 shows a top view of the lock washer of FIG. 2,

FIG. 4 shows an enlarged view of the detail of the lock washer of FIG. 2.

FIG. 5 shows a side view of the detail of the lock washer of FIG. 4, incorporated into a screw connection, and

FIG. 6 shows an example clamping arrangement in which such a lock washer is used.

It is to be understood that the invention is not limited in application to the details of particular arrangements shown in the drawings, since the invention is capable of other embodiments. Embodiments and figures disclosed herein are to be considered illustrative rather than limiting.

### DETAILED DESCRIPTION

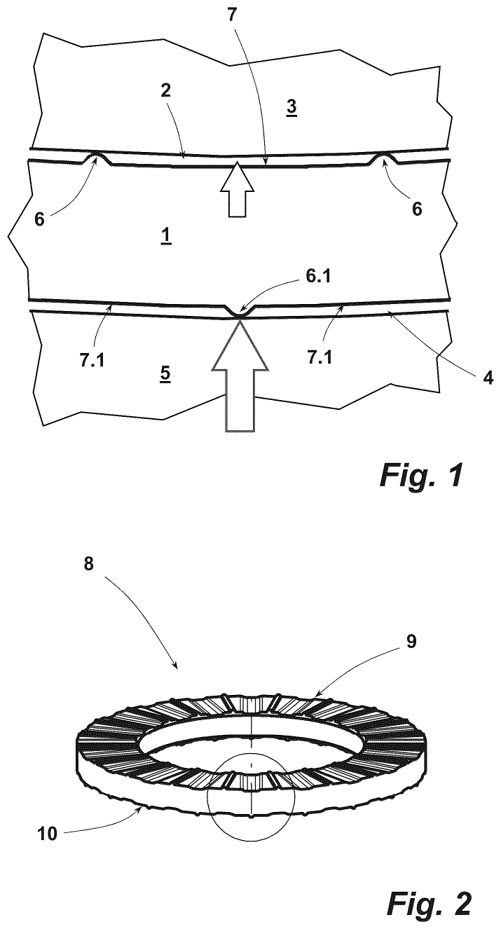

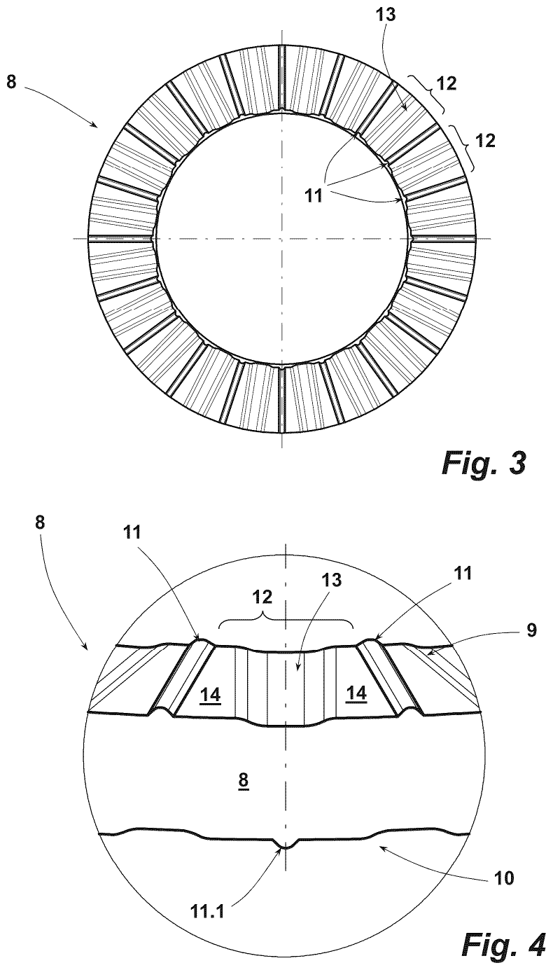

FIG. 1 shows a side detail view of a lock washer 1 on its outer side facing in the radial direction. The lock washer 1 is incorporated into a screw connection. On one flat side 2 of the lock washer 1, the lock washer 1 contacts a first clamping partner 3. On the opposite flat side 4, a clamping nut 5 abuts as the second clamping partner. A clamping bolt required for the screw connection is not shown in FIG. 1 for the sake of clarity. The lock washer 1 has a circular outline geometry. In its center there is a through-opening through which the bolt, for example the threaded shaft of a clamping bolt, is passed. Each flat side 2, 4 of the lock washer 1 bears a locking structure through which a relative movement in the circumferential direction between the clamping nut 5—on the one hand—and the clamping partner 3—on the other hand—acts. The locking structure of the flat side 2 has a plurality of positive structures spaced apart from one another in the circumferential direction, which in the illustrated example embodiment are designed as clamping ribs 6 extending in the radial direction. The clamping ribs 6 are formed like beads. The clamping ribs 6 have a convexly curved outer side and thus also a correspondingly curved vertex. The height of the clamping ribs 6 is smaller than their width in the circumferential direction. The clamping ribs 6 extend from the through-opening to the radial outer edge of the lock washer 6. The clamping ribs 6 are constant over their longitudinal extension with respect to their cross-sectional geometry and cross-sectional area. The clamping ribs 6 shown on the flat side 2 in FIG. 1 are separated from one another by a negative structure 7. The spacing of the clamping ribs 6 as positive structures from one another is a multiple of their width. At their end facing toward the through-opening, the spacing of the clamping ribs from one another is approximately 5 times their width. The opposite flat side 4 has an identical locking structure, wherein its positive structures designed as clamping ribs 6.1 are arranged offset in the circumferential direction of the lock washer 1 to those of the flat side 2. The offset is selected such that the clamping ribs 6.1 are offset from the clamping ribs 6 of the flat side 2 by half the spacing between them. Thus, the clamping ribs 6.1 of the flat side 4 are opposite to the centers of the negative structures 7, seen in the circumferential direction, on the flat side 2.

The material thickness of the lock washer 1 in the illustrated example embodiment is 3.5 mm. The shape of the lock washer 1 was produced by a stamping process. The locking structure on its flat sides 2, 4 was created during an embossing pressing process. The clamping ribs 6, 6.1 are thus the result of a forming process with respect to their shape. These are therefore work hardened and have a higher strength than the hardness of the other areas of the lock washer 1.

When installed in a screw connection, at the beginning of the clamping process the vertices of the clamping ribs 6, 6.1 are supported on the surface of the clamping partner 3 or 5 respectively abutting thereon, as is schematically indicated in FIG. 1. If the screw connection is tightened—in FIG. 1 the clamping force is indicated by block arrows—the clamping ribs 6, 6.1 are pressed into the material of the clamping partner 3, 5 abutting the respective flat side 2, 4. In this way, a form-fit acting in the circumferential direction is achieved between the lock washer and the clamping partner 3, 5 respectively abutting a flat side 2, 4. As long as the clamping ribs 6, 6.1 are not yet completely pressed into the material of the abutting clamping partner-even then an effective anti-loosening or anti-rotation lock is already present-a clamping force acting in the axial direction is incorporated into the lock washer 1 due to the offset of the clamping ribs 6 on the flat side 2 in relation to the clamping ribs 6.1 on the flat side 4, which acts on the screw connection in the manner of a wave spring. In FIG. 1, this is indicated on the flat side 2 by a block arrow. This pre-tension introduced in the area of clastic deformability of the lock washer 1 secures the screw connection particularly effectively, in particular if the screw connection is used in an environment with vibrations.

This pre-tension incorporated into the lock washer 1 also supports the clamping process if the clamping process is to be carried out until the negative structures on both flat sides 2, 4 contact the clamping partner 3 or 5 abutting thereon. The advantages resulting from the incorporation of the above-described preload in the locking washer 1 are achieved as long as the negative structures on a flat side 2, 4 do not fully contact the surface of the clamping partner 3 or 5 abutting thereon.

FIG. 2 shows a lock washer 8 which is basically constructed like the lock washer 1 of FIG. 1. The lock washer 8 differs from the lock washer 1 in the design of the locking structure of its two flat sides 9, 10. While the positive structures designed as clamping ribs 11 are identical to the clamping ribs 6, 6.1 of the lock washer 1, the negative structures 12 in the lock washer 8 are structured in the circumferential direction. The negative structures 12 are embodied as stepped on the two flat sides 9, 10 of the lock washer 8 and comprise a central section 13 which has a greater depth than the contact surface sections 14 adjacent thereto in the circumferential direction, which each border on a clamping rib 11. The contact surface sections 14 are used to provide a planar contact with the abutting clamping partner. On the other hand, section 13, with its greater depth and its flanks designed as inclined towards the greater depth, serves the purpose of ensuring that this section does not come into contact with the surface of the clamping partner abutting this flat side 9 or 10. The transition from the contact surface sections 14 into the section 13 takes place in this example embodiment in the manner of a flexure having curved transitions into the respective flank. The section 13 having the greater depth is opposite to a clamping rib 11.1 on the opposite flat side 10. The width of the section 13, viewed in the circumferential direction, is multiple times greater than the width of the clamping rib 11.1 located on the opposite flat side. The section 13 extends over the entire radial extension of the lock washer 8 and is constant in terms of its cross-sectional geometry and size over its radial extension.

Due to this design of the lock washer 8, a screw connection having such a locking washer 8 can be tightened enough that the contact surface sections 14 contact the surface of the abutting clamping partner. Thus, the lock washer 8 meets the requirements of a planar contact, wherein a pre-tension acting in the axial direction is nevertheless incorporated into the lock washer 8 by the section 13. Since, just as in the example embodiment of the lock washer 1, the two flat sides 9, 10 also bear the same locking structure in the lock washer 8, which are arranged offset from one another in the circumferential direction in the manner described above, the effective depth of a negative structure does not have to be excessively deep despite the buildup of a pre-tension in the manner of a wave spring.

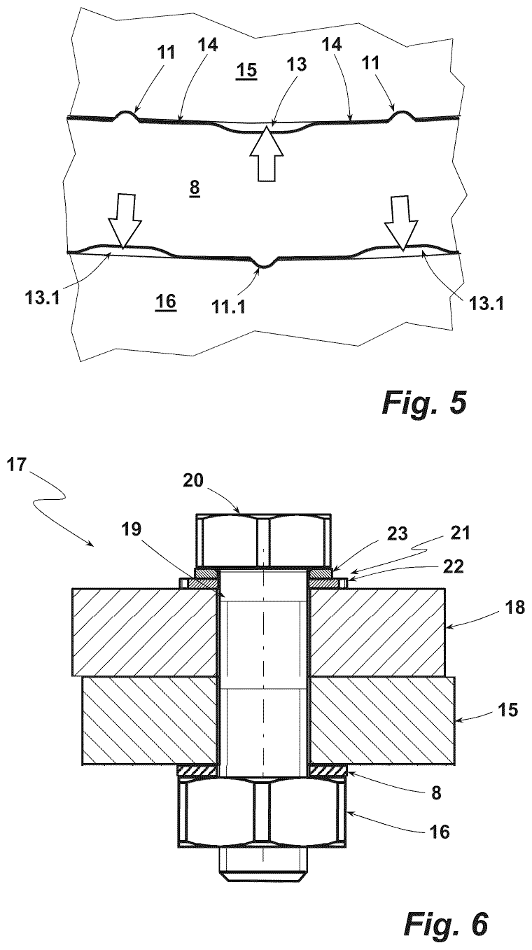

FIG. 5 shows the lock washer 8 installed in a screw connection after completion of the clamping process, so that the contact surface sections 14 abut the upper side of the clamping partner abutting thereon. The flat side 9 of the lock washer 8 abuts a clamping partner 15 and the flat side 10 abuts a clamping nut 16. In this figure, as in FIG. 1, the pre-tension incorporated into the lock washer 8 by the special design of the negative structures 12 having their sections 13, 13.1 is shown schematically by block arrows.

The lock washers 1, 8 are not only suitable for use as anti-loosening devices, but also for creating a screw connection where otherwise a clamping partner, for example a clamping nut, would have to be counter-tightened. Due to insertion of a lock washer 1, 8, this is not necessary. Rather, the screw connection can be pre-tensioned by hand enough that there is no risk of the clamping nut on the side on which a clamping nut is arranged also turning when the screw connection is tightened from the other side. Such clamping is necessary, for example, when connecting two flanges of a drive shaft, for example, in particular drive shafts having larger diameters, such as those used in wind turbines. On the side of the clamping connection opposite to the lock washer 1 or 8, a further lock washer is inserted into the screw connection, which preferably has rotational drive structures on its outer circumference and this lock washer is therefore a reaction washer. According to a preferred example embodiment, such a reaction washer is embodied by a pair of lock washers in the manner of a pair of wedge lock washers.

FIG. 6 shows the clamping arrangement 17, which is only shown in a detail with respect to the lock washer 8, via which the clamping nut 16 is connected to the clamping partner 15 in a rotationally-fixed manner. The clamping partner 15 is connected to a further clamping partner 18 by the clamping arrangement 17. The clamping nut 16 is screwed onto the threaded shaft of a clamping bolt 19. A pair of wedge lock washers 21 is inserted between the bolt head 20 and the surface of the clamping partner 18 facing toward the bolt head 20. A special feature of the pair of wedge lock washers 21 is that one of the two wedge lock washers, namely the wedge lock washer 22, has a larger diameter than the wedge lock washer 23. The section of the wedge lock washer 22 that projects beyond the diameter of the smaller wedge lock washer 23 in the radial direction has rotational drive contours on the outside that are introduced in the radial direction, into which the torque support of a motor-driven rotary tool engages when the clamping arrangement 17 is clamped and is thus supported via this. As a result of the special locking effect of the lock washer 8, the clamping arrangement 17 can be clamped solely from one side. In this case, it is only necessary that the clamping bolt 19 is tightened using a screwing tool, without the need to hold or secure the clamping nut 16 using a second tool.

The invention has been described on the basis of exemplary embodiments. Without departing the scope of the present claims, there are numerous other designs and options for a person skilled in the art to implement the invention, without these having to be shown or explained in more detail in the context of this disclosure.

While several aspects and embodiments have been discussed herein, those persons skilled in the art will recognize numerous possible modifications, permutations, additions, combinations and sub-combinations therefor, without these needing to be specifically explained or shown within the context of this disclosure. The claims should therefore be interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown or described, or portions thereof, but it is recognized that various modifications are possible within the scope of the invention. Thus, it should be understood that although the invention has been specifically disclosed by preferred embodiments and optional features, modification and variation of the concepts herein may be resorted to by those skilled in the art, and that such modifications and variations are considered to be within the scope of this invention as defined by the claims. Whenever a range is given in the specification, all intermediate ranges and subranges, as well as all individual values included in the ranges given are hereby incorporated into this disclosure. When a Markush group or other grouping is used herein, all individual members of the group and all combinations and sub-combinations possible of the group are hereby individually included in this disclosure. In general, the terms and phrases used herein have their art-recognized meaning, which can be found by reference to standard texts, references and contexts known to those skilled in the art. Any above definitions are provided to clarify their specific use in the context of the invention.

### LIST OF REFERENCE NUMERALS

1 lock washer
2 flat side
3 clamping partner
4 flat side
5 clamping nut
6, 6.1 clamping rib
7 negative structure
8 lock washer
9 flat side
10 flat side
11, 11.1 clamping rib
12 negative structure
13, 13.1 section
14 contact surface section
15 clamping partner
16 clamping nut
17 clamping arrangement
18 clamping partner
19 clamping bolt
20 bolt head
21 pair of wedge lock washers
22 wedge lock washer
23 wedge lock washer

1. A lock washer comprising:
a first flat side, a second flat side opposite the first flat side, and a central through-opening axially extending between the two flat sides for passage of a clamping shaft therethrough, wherein each flat side has a locking structure with positive structures and negative structures alternating in the circumferential direction of the lock washer,
wherein the positive structures and the negative structures extend in the radial direction, with the negative structures extending, starting from the through-opening, over the radial extension of the lock washer up to a radial outer edge of the lock washer,
wherein all of the positive structures of the locking structure on the first flat side are arranged offset in the circumferential direction of the lock washer in relation to the positive structures on the second flat side, and
wherein each respective positive structure on the two flat sides is arranged opposite a respective negative structure on the other flat side, and the width of the respective negative structure in the circumferential direction of the lock washer corresponds to a multiple of the width of the respective positive structure in the circumferential direction, and
wherein each respective negative structure has a greatest depth in a lower section thereof arranged opposite to the respective positive structure on the other flat side, and
wherein the negative structures are each formed stepped in a course thereof in the circumferential direction, with each negative structure having two flat contact surface sections separated from one another by the lower section and connected thereto by flanks inclined relative to the lower section, and
wherein the positive structures on the two flat sides of the lock washer are formed as clamping ribs which extend in the radial direction.

2. (canceled)

3. The lock washer of claim 1, wherein the clamping ribs have a height which does not exceed the width thereof extending in the circumferential direction.

4. The lock washer of claim 3, wherein the height of the clamping ribs is 40 to 60% of the width of the clamping ribs.

5. The lock washer of claim 1, wherein the clamping ribs extend, starting from the through-opening, up to the radial outer edge of the lock washer.

6. The lock washer of claim 5, wherein the clamping ribs have a straight course in the radial direction.

7. The lock washer of claim 21, wherein the clamping ribs have a constant cross-sectional geometry and cross-sectional area over their radial extension.

8. The lock washer of claim 1, wherein the negative structures have a constant cross-sectional geometry in their radial extension.

9-10. (canceled)

11. The lock washer of claim 101, wherein the two flat contact surface sections, which each border a respective one of two adjacent positive structures, are located in the plane of the respective flat side of the lock washer for contacting a surface of a clamping partner abutting the respective flat side of the lock washer.

12. The lock washer of claim 1, wherein the lower section of the greatest depth of the negative structures has a greater extension in the circumferential direction than the respective positive structure located on the opposite flat side in the circumferential direction.

13. The lock washer of claim 12, wherein, in each segment of the locking structure in the circumferential direction defined by a positive structure and a negative structure, a ratio of the width of the positive structure to that of the negative structure is between 1:4 and 1:7 at the ends of these structures adjacent to the through-opening.

14. The lock washer of claim 13, wherein the ratio is approximately 1:5.

15. The lock washer of claim 1, wherein, in the circumferential direction of the lock washer, a span between vertices of two adjacent positive structures on the radial outer edge of the lock washer is greater than a thickness of the lock washer between the two flat sides but less than 2.5 times the thickness thereof.

16. (canceled)

17. The lock washer of claim 1, wherein the locking structure on the two flat sides of the lock washer is formed by a pressing process.

18. The lock washer of claim 17, wherein the positive structures are formed by a cold forming process.

19. The lock washer of claim 1, wherein a mouth of the through-opening on each flat side of the lock washer is formed with a chamfer.
